(19) United States
(12) Patent Application Publication
(10) Pub. No.: US 2025/0273414 A1
(43) Pub. Date: Aug. 28, 2025

(54) REMOTELY-CONTROLLED ROTARY DISCONNECTING SWITCH

(71) Applicant: Chint Low Voltage Electrical Technology Co., Ltd., Songjiang District, Shanghai (CN)

(72) Inventors: Zhe GU, Songjiang District, Shanghai (CN); Weijun GE, Songjiang District, Shanghai (CN); Changqing ZHOU, Songjiang District, Shanghai (CN); Jiapeng JIANG, Songjiang District, Shanghai (CN)

(21) Appl. No.: 18/856,508

(22) PCT Filed: Sep. 6, 2023
(86) PCT No.: PCT/CN2023/117131

§ 371 Date: Oct. 11, 2024

(30) Foreign Application Priority Data
Sep. 7, 2022 (CN) 202211132427.8

(51) Int. Cl. H01H 19/14; H01H 3/30; H01H 19/06

(52) U.S. Cl. CPC H01H 19/14; H01H 3/3031; H01H 19/06; H01H 2003/3068; H01H 2003/3089

(57) ABSTRACT

A remotely-controlled rotary disconnecting switch that includes an operating device and a switch body, which includes at least one switch unit. Each switch unit includes a moving contact assembly and a static contact. The operating device drives the moving contact assembly to rotate to be connected to or disconnected from the static contact to connect or disconnect. The operating device includes an operating shaft, a real-time energy storage mechanism, a delayed energy storage mechanism, a locking mechanism with a locking fastener and a tripping mechanism with a trip that actuates to drive the locking fastener to be unlocked from the delayed energy storage mechanism, the delayed energy storage mechanism releases energy to drive the operating shaft to rotate to an opening position, and then the operating shaft drives the real-time operation mechanism to drive the remotely-controlled rotary disconnecting switch to be switched to an opened state.

### TECHNICAL FIELD

The present invention relates to the field of low-voltage electrical appliances, and more particularly, to a remotely-controlled rotary disconnecting switch.

### BACKGROUND

A rotary disconnecting switch generally consists of an operating device and a switch body which are in driving connection with each other, wherein the switch body includes a plurality of switch units which is stacked together and synchronously closed or disconnected under the drive of the operating device. With the wide application of rotary disconnecting switches, new functional requirements are put forward for the rotary disconnecting switches. That is, when a system line fails, the rotary disconnecting switch has a remote tripping function, and may be manually closed when the fault is cleared, while the remote tripping function does not affect manual closing and opening operations of the disconnecting switch.

When the existing rotary disconnecting switch releases energy from its delayed energy storage mechanism, this disconnecting switch is driven directly by a real-time energy storage mechanism to be opened, resulting in a complex structure and poor stability of the rotary disconnecting switch.

### SUMMARY

An object of the present invention is to overcome the defects of the prior art and provide a remotely-controlled rotary disconnecting switch with good reliability.

In order to achieve the above object, the present invention adopts the following technical solutions:

A remotely-controlled rotary disconnecting switch, comprising an operating device and a switch body, wherein the switch body comprises at least one switch unit, and each switch unit comprises a moving contact assembly which is arranged rotatably and a static contact which cooperates with the moving contact assembly; the operating device is in driving connection with the moving contact assembly of the switch unit and drives the moving contact assembly to rotate to be connected to or disconnected from the static contact, so that a circuit is connected or disconnected; the operating device comprises an operating shaft which is arranged rotatably around its own axis, a real-time energy storage mechanism, a delayed energy storage mechanism, a locking mechanism and a tripping mechanism; the locking mechanism comprises a locking fastener; the tripping mechanism comprises a trip; when the remotely-controlled rotary disconnecting switch is in an opened state and the delayed energy storage mechanism is in an energy-release state, the operating shaft rotates from an opening position toward a closing position and drives the operating device to be switched to a closed state through the real-time energy storage mechanism, and meanwhile drives the delayed energy storage mechanism to be switched to an energy-storage state and to be in locking fit with the locking fastener, such that the delayed energy storage mechanism is kept in the energy-storage state; when the delayed energy storage mechanism is in the energy-storage state, the operating shaft rotates freely between the opening position and the closing position, and meanwhile drives the remotely-controlled rotary disconnecting switch to be switched freely between the opened state and the closed state; and upon receiving a tripping signal the trip actuates to drive the locking fastener to be unlocked from the delayed energy storage mechanism, then the delayed energy storage mechanism releases energy to drive the operating shaft to rotate toward the opening position, and the operating shaft in turn drives the real-time energy storage mechanism to drive the remotely-controlled rotary disconnecting switch to be switched to the opened state.

Preferably, the delayed energy storage mechanism comprises a turntable and a first energy storage spring; the turntable is driven by the operating shaft to rotate from an energy-release position to an energy-storage position, such that the first energy storage spring stores energy; and the turntable is in locking fit with the locking fastener, such that the delayed energy storage mechanism is kept in the energy-storage state; and
when the remotely-controlled rotary disconnecting switch is in the closed state, there is an opening idle stroke between the turntable and the operating shaft, and the operating shaft is driven by an external force to rotate, such that the operating shaft drives the remotely-controlled rotary disconnecting switch to be switched to the opened state through the real-time energy storage mechanism, and passes by the opening idle stroke relative to the turntable simultaneously.

Preferably, the turntable is coaxially mounted with the operating shaft; the turntable comprises a turntable shaft hole and at least one turntable driven hole; the turntable is rotatably sleeved onto the operating shaft through the turntable shaft hole; the turntable driven hole comprises a first surface and a second surface;
the operating shaft comprises a driving finger, wherein the driving finger is arranged within the turntable driven hole;
the driving finger presses against the first surface, such that the turntable rotates toward the energy-storage position; and
when the remotely-controlled rotary disconnecting switch is in the closed state, an opening idle stroke is formed between the second surface and the driving finger; and when the delayed energy storage mechanism releases energy, the first energy storage spring releases energy and drives the turntable to rotate toward the energy-release position, and the first surface drives the operating shaft to rotate toward the opening position through the driving finger.

Preferably, the turntable driven hole is a sector-shaped hole that is concentric with the turntable shaft hole; the sector-shaped hole is provided with a first surface and a second surface at two ends of itself in a circumferential direction, respectively.

Preferably, the turntable further comprises a turntable locking arm; one end of the locking fastener is rotatably arranged, and another end of the locking fastener is adapted to cooperate with the trip; the locking fastener comprises a locking fastener locking part arranged in a middle of the locking fastener; the turntable rotates from the energy-release position toward the energy-storage position, and the turntable locking arm presses against the locking fastener locking part, such that the locking fastener rotates in a first direction to avoid the turntable locking arm; after the turntable locking arm crosses over the locking fastener locking part, the locking fastener rotates and resets in a second direction, and is in a limiting fit with the turntable locking arm, such that the turntable is locked in the energy-storage position; the first direction and the second direction are opposite to each other; and upon receiving a tripping signal, the trip actuates to drive the locking fastener to rotate in the first direction, such that the locking fastener disengages from the limiting fit with the turntable locking arm.

Preferably, the first energy storage spring is a torsion spring, and the first energy storage spring, the turntable and the operating shaft are coaxially arranged; and the delayed energy storage mechanism further comprises a first bushing, wherein the first bushing, which is rotatably sleeved onto the operating shaft and is located between the first energy storage spring and the operating shaft.

Preferably, the real-time energy storage mechanism comprises a second energy storage spring, a sliding frame, a rotating frame, an output shaft and a housing base; the output shaft is rotatably arranged on the housing base around its own axis; the rotating frame is fixedly connected to and rotates synchronously with the operating shaft; the sliding frame rotates in synchronization with the output shaft and is slidably arranged relative to the housing base and the output shaft; and the housing base comprises two limiting grooves, i.e., an opening groove and a closing groove respectively, which are distributed at intervals in a rotation direction of the output shaft;

when the sliding frame is in a limiting fit with one limiting groove, the operating shaft drives the rotating frame to rotate, such that the second energy storage spring stores energy till the rotating frame gets to engage with the sliding frame; the operating shaft continues to rotate and drives the sliding frame through the rotating frame to slide out of the limiting groove relative to the housing base; the second energy storage spring releases energy and drives the sliding frame to rotate and slide into the other limiting groove; and the sliding frame drives the output shaft to rotate simultaneously.

Preferably, the second energy storage spring is a torsion spring; the second energy storage spring, the rotating frame, the output shaft and the operating shaft are coaxially arranged; the second energy storage spring, the rotating frame, the sliding frame and the output shaft are arranged sequentially; the real-time energy storage mechanism further comprises a second bushing, which is rotatably sleeved onto the operating shaft and is inserted between the operating shaft and the second energy storage spring.

Preferably, the operating device further comprises a device housing; the device housing comprises a first space for accommodating the delayed energy storage mechanism and a second space for accommodating the real-time energy storage mechanism; the first space and the second space are distributed in an axial direction of the operating shaft; a partition plate is arranged between the first space and the second space, and is provided with a partition plate shaft hole for the operating shaft to pass through; and one end of the operating shaft protrudes outside the device housing for operation, and another end is inserted into the second space through the first space and the partition plate shaft hole sequentially.

Preferably, the device housing comprises an upper housing cover, a housing partition plate and a housing base which are arranged sequentially; the upper housing cover and the housing partition plate are buckled to enclose the first space; the housing partition plate and the housing base are buckled to enclose the second space; and the housing partition plate comprises a partition plate.

Preferably, the delayed energy storage mechanism further comprises a gasket; the gasket is arranged on the housing partition plate of the device housing; and the turntable of the delayed energy storage mechanism is rotatably arranged on the gasket.

Preferably, the gasket comprises a gasket avoidance hole for the operating shaft to pass through, a gasket counterbore arranged on the side of the gasket facing the turntable, and a gasket opening; the gasket counterbore has an inner diameter greater than an inner diameter of the gasket avoidance hole; the gasket opening is communicated with the gasket counterbore; a driving key of the delayed energy storage mechanism enters the gasket counterbore via the gasket opening, is inserted into the operating shaft, and rotates within the gasket counterbore.

Preferably, a first energy storage spring of the delayed energy storage mechanism is a torsion spring; two ends of the tension spring are respectively a first spring fixed end and a first spring driven end; the first spring fixed end is fixedly arranged on the housing partition plate; the first spring driven end cooperates with the turntable of the delay energy storage mechanism; the housing partition plate comprises a turntable stopper; and when the delayed energy storage mechanism is in an energy-release state, and the turntable is in a limiting fit with the turntable stopper, so that the turntable is stopped at the energy-release position.

Preferably, the turntable comprises a turntable main board, and a turntable locking arm and a turntable cooperation arm which are respectively arranged on the turntable main board; the turntable cooperation arm cooperates with the first spring cooperation end; when the delayed energy storage mechanism is in the energy-storage state, the turntable locking arm is in locking fit with the locking fastener; when the delayed energy storage mechanism is in the energy-release state, the turntable locking arm is in a limiting fit with the turntable stopper.

According to the remotely-controlled rotary disconnecting switch of the present invention, the delayed energy storage mechanism implements a remote tripping and opening function, without affecting the manual operation of the operating shaft to drive the operating device to be opened and closed; and the delayed energy storage mechanism releases energy and drives the operating device to be opened through the operating shaft, which is conducive to improving the working reliability and stability of the remotely-controlled rotary disconnecting switch.

In addition, the layout of the operating device is reasonable, which is conducive to reducing the overall structural complexity of the operating device, convenient for assembly and installation, and improving the working reliability and stability of the operating device.

### BRIEF DESCRIPTION OF THE DRAWINGS

FIG. 1 is a schematic diagram of an overall three-dimensional structure of a rotary disconnecting switch of the present invention;

FIG. 2 is a schematic structural diagram of an operating device and a switch body which are split in the present invention;

FIG. 3 is a schematic structural diagram of the switch body in the present invention, with the switch body being composed of a plurality of switch units that is stacked;

FIG. 4 is a schematic diagram of projections of a delayed energy storage mechanism, a locking mechanism and a tripping mechanism in the present invention, in which the delayed energy storage mechanism is in an energy-release state;

FIG. 5 is a schematic diagram of a three-dimensional structure of the delayed energy storage mechanism, the locking mechanism and the tripping mechanism in the present invention, in which the delayed energy storage mechanism is during a process of switching from an energy-release state to the energy-storage state;

FIG. 6 is a schematic diagram of projections of the delayed energy storage mechanism, the locking mechanism and the tripping mechanism in the present invention, in which the delayed energy storage mechanism is in the energy-storage state;

FIG. 7 is a schematic diagram of a three-dimensional structure of the delayed energy storage mechanism, the locking mechanism and the tripping mechanism in the present invention, in which the delayed energy storage mechanism is in the energy-storage state;

FIG. 8 is a schematic diagram of a three-dimensional structure of the delayed energy storage mechanism, the locking mechanism and the tripping mechanism in the present invention, in which the tripping mechanism is in an untripped state;

FIG. 9 is a schematic diagram of a three-dimensional structure of the delayed energy storage mechanism and the tripping mechanism in the present invention, in which the tripping mechanism is in a tripped state;

FIG. 10 is a schematic diagram of a three-dimensional structure of a real-time energy storage mechanism in the present invention;

FIG. 11 is a schematic exploded view of the real-time energy storage mechanism in the present invention;

FIG. 12 is a schematic diagram of an assembled structure of an operating shaft, a first energy storage spring and a rotary frame in the present invention;

FIG. 13 is a schematic diagram of an assembled structure of a sliding frame and an output shaft in the present invention;

FIG. 14 is a schematic diagram of an assembled structure of the sliding frame and the output shaft from another perspective in the present invention;

FIG. 15 is a schematic diagram of a projection of the real-time energy storage mechanism in the present invention, in which the operating shaft is in an opening position;

FIG. 16 is a schematic diagram of a three-dimensional structure of the real-time energy storage mechanism in the present invention, in which the operating shaft is during a process of rotating from the opening position to a closing position, and the sliding frame is in initial contact limiting with the sliding frame;

FIG. 17 is a schematic diagram of a projection of the real-time energy storage mechanism in the present invention, in which the operating shaft is during a process of rotating from the opening position to the closing position, and the sliding frame escapes from an opening groove;

FIG. 18 is a schematic diagram of a three-dimensional structure of the real-time energy storage mechanism in the present invention, in which the operating shaft is in the closing position;

FIG. 19a is a schematic diagram of an exploded structure of the delayed energy storage mechanism in the present invention;

FIG. 19b is a schematic structure diagram of the delayed energy storage medium in the present invention, showing a cooperative relationship between a driving finger and a turntable;

FIG. 20 is a schematic structural diagram of a gasket in the present invention;

FIG. 21 is a schematic structural diagram of a turntable in the present invention;

FIG. 22 is a schematic structural diagram of a first bushing in the present invention;

FIG. 23 is a schematic sectional view of a housing in the present invention;

FIG. 24 is a schematic exploded view of the housing in the present invention;

FIG. 25a is a schematic structural diagram of a housing panel in the present invention;

FIG. 25b is a schematic structural diagram of an upper housing cover in the present invention;

FIG. 25c is a schematic structural diagram of a housing partition plate in the present invention;

FIG. 25d is a schematic structural diagram of a housing base in the present invention;

FIG. 26a is a schematic structural diagram of a locking fastener in the present invention;

FIG. 26b is a schematic diagram of the cooperation of the locking fastener and the turntable in the present invention;

FIG. 27 is a schematic diagram of a projection of a switch unit in the present invention;

FIG. 28 is a schematic exploded view of the switch unit in the present invention;

FIG. 29 is a schematic structural diagram of a unit housing in the present invention;

FIG. 30 is a schematic diagram of a three-dimensional structure of a moving contact rotating shaft in the present invention;

FIG. 31 is a schematic sectional view of the moving contact rotating shaft in the present invention;

FIG. 32 is a schematic exploded view of a handle, a handle connecting screw and an operating shaft in the present invention; and

FIG. 33 is a schematic structural diagram of the handle in the present invention.

### REFERENCE SYMBOLS REPRESENT THE FOLLOWING COMPONENTS

s1—first space; s2—second space; p—partition plate; 1—operating device; 101—housing base; 1010u—base assembling groove; 1010m—base counterbore; 1011d—base shaft hole; 1012-13—opening groove; 1012—first opening groove side surface; 1013—second opening groove side surface; 1015-16—closing groove; 1015—first closing groove side surface; 1016—second closing groove side surface; 102—housing partition plate; 1021—gasket mounting groove; 1023—partition plate shaft hole; 1025—housing partition plate spring limiting groove; 1026—turntable stopper; 103—upper housing cover 103; 1031—upper cover shaft hole; 104—housing panel; 111—output shaft; 1110—output shaft driven part; 1111—output shaft driving part; 1114—driving part connecting hole; 1112—sliding boss; 1113—output shaft positioning hole; 112—sliding frame; 1120—sliding frame bottom plate; 1122c—closed sliding frame arm; 11220—opened sliding frame arm; 1123—sliding frame limiting end; 1124—sliding frame chute; 1131—operating shaft; 11311—operating shaft positioning column; 11312—annular groove; 11313—operating shaft limiting surface; 11314—operating shaft jack; 11315—operating shaft screw hole; 1134—rotary frame; 11343—closed rotary frame arm; 11344—opened rotary frame arm; 11340—rotary frame bottom plate; 1132—sealing ring; 1133—second energy storage spring; 11331—second spring first-end; 11332—second spring second-end; 1135—second bushing; 114—nut; 121—gasket; 1211—gasket avoidance hole; 1212—gasket counterbore; 1214—first gasket clamping groove; 1215—second gasket clamping groove; 1216—gasket opening; 122—locking fastener; 1222—locking fastener main board; 1222-1—locking fastener resetting part; 1221—locking fastener driven part; 1223—locking fastener locking part; 1223-1—locking part guide surface; 1223-0—locking part latching surface; 123—locking fastener resetting element; 124—first bushing; 1241—first bushing body; 1242—first bushing head; 1245—sliding protrusion; 126—first energy storage spring; 1261—first spring fixed end; 1262—first spring driven end; 127—turntable; 1270—turntable main board; 1271—turntable shaft hole; 1273-74—turntable locking arm; 1275-77—turntable cooperation arm; 1275—turntable cooperation arm cooperation side edge; 1277—turntable cooperation arm limiting side edge; 1276—turntable driven hole; 12761—first surface; 12762—second surface; 128—driving key; 134—trip; 2—switch body; 221—unit housing; 2211—unit housing shaft hole; 2212—unit housing counterbore; 222—moving contact rotating shaft; 2221-22—rotating shaft base; 2221—rotating shaft base lower-segment; 2222—rotating shaft base upper-segment; 2223-24—rotating shaft column; 2223—rotating shaft column lower-segment; 2224—rotating shaft column upper-segment; 2226—rotating shaft base connecting hole; 2227—first blind hole; 2228—second blind hole; 223—static contact; 224—arc extinguishing chamber; 225—moving contact assembly; 3—screw rod; 4—handle; 41—handle connecting hole 41; and 5—handle connecting screw.

### DETAILED DESCRIPTION OF THE INVENTION

The specific implementations of a disconnecting switch of the present invention will be further described below in conjunction with the embodiments given in the accompanying drawings of the specification. The disconnecting switch of the present invention is not limited to the description of the following embodiments.

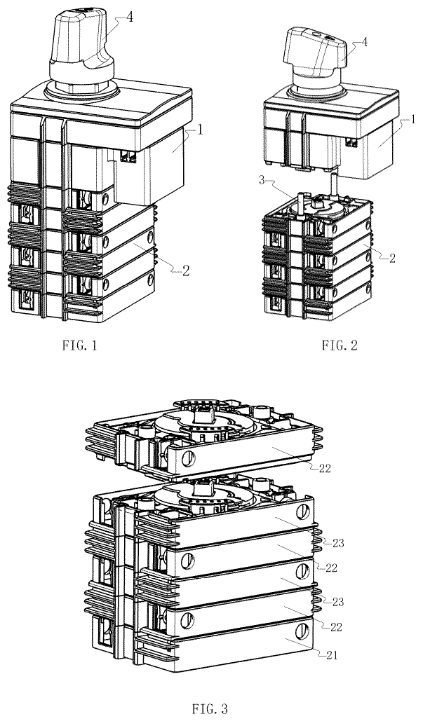

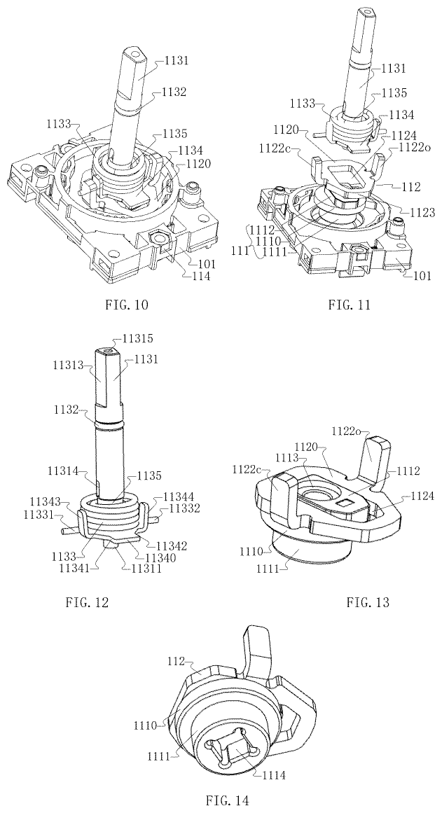

As shown in FIGS. 1-2, the present invention discloses a disconnecting switch, preferably a rotary disconnecting switch, and further preferably, a remotely-controlled rotary disconnecting switch. The remotely-controlled rotary disconnecting switch includes an operating device 1 and a switch body 2 that are in driving connection with each other, wherein the operating device 1 drives the switch body 2, such that a circuit is connected or disconnected. Further, the operating device 1 is fixedly connected to the switch body 2 through a connector. Further, as shown in FIGS. 2 and 10, the connector is preferably a bolt. The bolt includes a screw rod 3 and a nut 114, wherein the screw rod 3 passes through the switch body 2, and is then in threaded connection with the nut 114 fixed on the operating device 1. Of course, it is not excluded that the operating device 1 and the switch body 2 are connected in other ways, e.g., by means of a rivet or a buckle or ultrasonic welding or hot riveting, etc.

As shown in FIGS. 1-3, and 27, the switch body 2 includes at least one switch unit. The switch unit includes a moving contact assembly 225 that is rotatably arranged and a static contact 223 that cooperates with the moving contact assembly 225. The operating device 1 is in driving connection with the moving contact assembly 225 of the switch unit, and drives the moving contact assembly 225 to rotate so as to allow the static contact 223 to be closed or opened, such that the circuit is connected or disconnected. Further, the switch body 2 includes a plurality of switch units arranged in a laminated manner, and the moving contact assemblies 225 of the respective switch units are arranged rotatably in linkage.

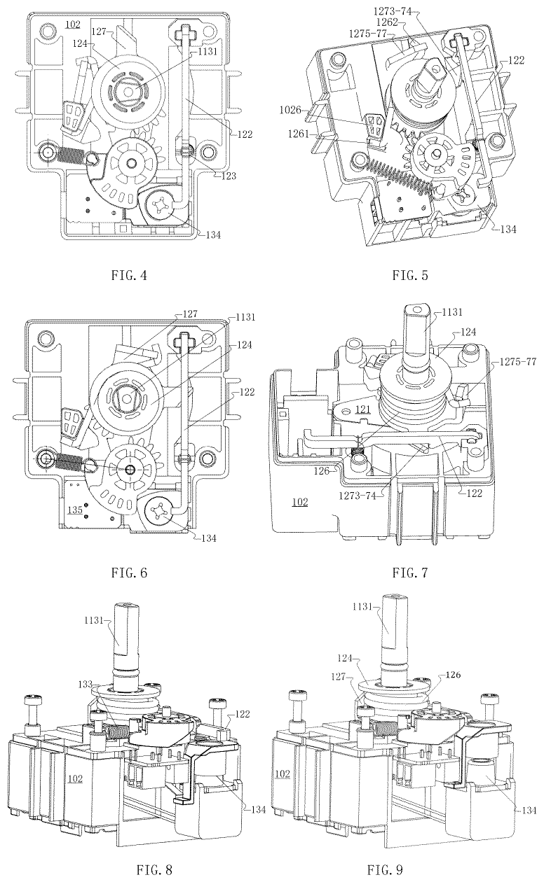

As shown in FIGS. 4-12, the opening mechanism 1 includes an operating shaft 1131 arranged rotatably around its own axis, a delayed energy storage mechanism, a real-time energy storage mechanism, a locking mechanism, and a tripping mechanism. The operating shaft 1131 rotates between an opening position and a closing position to output an opening and closing operation force to the real-time energy storage mechanism. The real-time energy storage mechanism includes a second energy storage spring 1133. The operating shaft 1131 is in transmission fit with the real-time energy storage mechanism, and is used for driving the second energy storage spring 1133 to first store energy and then release energy, so that the operating device 1 is driven to be quickly switched between an opened state and a closed state, and the operating device 1 drives the switch body 2, such that the circuit is disconnected and connected quickly. When the operating shaft 1131 rotates from a closing position to an opening position, the operating device 1 is driven by the real-time energy storage mechanism to be switched to the opened state; and when the operating shaft 1131 is switched from the opening position to the closing position, the operating device 1 is driven by the real-time energy storage mechanism to be switched to the closed state. The delayed energy storage mechanism includes a first energy storage spring 126. The delayed energy storage mechanism has an energy-storage state with the first energy storage spring 126 completing energy storage and an energy-release state with the first energy storage spring 126 completing energy release. The locking mechanism is used for locking the delayed energy storage mechanism in the energy-storage state. The tripping mechanism is used for triggering the locking mechanism to release locking fit from the delayed energy storage mechanism, so that the delayed energy storage mechanism releases energy, and is switched from the energy-storage state to the energy-release state, in order to drive the operating device 1 to be switched from the closed state to the opened state. When the operating shaft 1131 rotates from the opening position to the closing position, the delayed energy storage mechanism is driven to be switched from the energy-release state to the energy-storage state, and the delayed energy storage mechanism is in locking fit with the locking mechanism, such that the delayed energy storage mechanism is locked in the energy-storage state. When the delayed energy storage mechanism is locked in the energy-storage state by the locking mechanism, the operating shaft 1131 is avoided, that is, the operating shaft 1131 rotates between the closing position and the opening position at this moment without affecting the state of the delayed energy storage mechanism. That is, when the operating device 1 is in the opened state and the delayed energy storage mechanism is in the energy-release state, the operating shaft 1131 rotates from the opening position to the closing position, drives the operating device 1 to be switched to the closed state through the real-time energy storage mechanism, and meanwhile drives the delayed energy storage mechanism to be switched to the energy-storage state, and the delayed energy storage mechanism is in locking fit with the locking mechanism to keep in the energy-storage state. When the delayed energy storage mechanism is in the energy-storage state, the operating shaft 1131 is freely switched between the closing position and the opening position. That is to say, an external force can be directly exerted to the operating shaft 1131, such that the operating shaft is driven to rotate between the opening position and the closing position, in order to drive the operating device 1 to be switched freely between the opened state and the closed state, without affecting the state of the delayed energy storage mechanism. When the operating device 1 is in the closed state and the delayed energy storage mechanism is in the energy-storage state, after the tripping mechanism receives a tripping signal, the locking mechanism is driven to release locking fit from the delayed energy storage mechanism, and the delayed energy storage mechanism releases energy and drives the operating device 1 to be switched to the opened state. The operating shaft 1131 rotates in two opposite directions so as to rotate between the opening position and the closing position. Therefore, the operating device 1 can be opened in two ways. One way is to screw the operating shaft 1131 with an external force to drive the operating device 1 to be opened manually. The other way is to input the tripping signal to the tripping mechanism in a remote control mode. The tripping mechanism actuates to trigger the delayed energy storage mechanism to release energy, and the delayed energy storage mechanism drives the operating device 1 to be opened, thereby implementing remote opening control for the rotary disconnecting switch.

Further, the locking mechanism includes a locking fastener 122. The locking fastener 122 is used for being in locking fit with the delayed energy storage mechanism, such that the delayed energy storage mechanism is locked in the energy-storage state. The tripping mechanism includes a trip 134. The trip 134 is preferably a magnetic flux trip, which is used for driving the locking fastener 122 to actuate, such that the locking fastener 122 releases locking fit from the delayed energy storage mechanism. After the delayed energy storage mechanism is switched to the energy-storage state, it is in locking fit with the locking fastener 122 to keep in the energy-storage state. Upon the tripping mechanism receives the tripping signal, the trip 134 actuates to drive the locking fastener 122 to release locking fit from the delayed energy storage mechanism.

As shown in FIGS. 1-11, 15-19b, and 23-25d, the operating device 1 further includes a device housing, and the delayed energy storage mechanism, the real-time energy storage mechanism, the locking mechanism and the tripping mechanism are all arranged in the device housing. Further, as shown in FIG. 23, the device housing includes a first space s1 and a second space s2 which are arranged in an axial direction of the operating shaft 1131. A partition plate p is arranged between the first space s1 and the second space s2. The time-delay energy storage mechanism is arranged in the first space s1. The real-time energy storage mechanism is arranged in the second space s2. The partition plate p is provided with a partition plate shaft hole 1023 for the operating shaft 1131 to pass through. The operating shaft 1131 is rotatably inserted into the first space s1 and the second space s2 and cooperates respectively with the delayed energy storage mechanism and the real-time energy storage mechanism. One end of the operating shaft 1131 protrudes out of the device housing for external operation, and the other end of the operating shaft 1131 is inserted into the second space S2 after passing through the first space S1 and the partition plate P sequentially. Further, as shown in FIGS. 23-25d, the device housing includes an upper housing cover 103, a housing partition plate 102 and a housing base 101 that cooperate with each other sequentially. The upper housing cover 103 and the housing partition plate 102 are buckled to enclose the first space s1. The housing partition plate 102 and the housing base 101 are buckled to enclose the second space s2. The housing partition plate 102 includes a partition plate p.

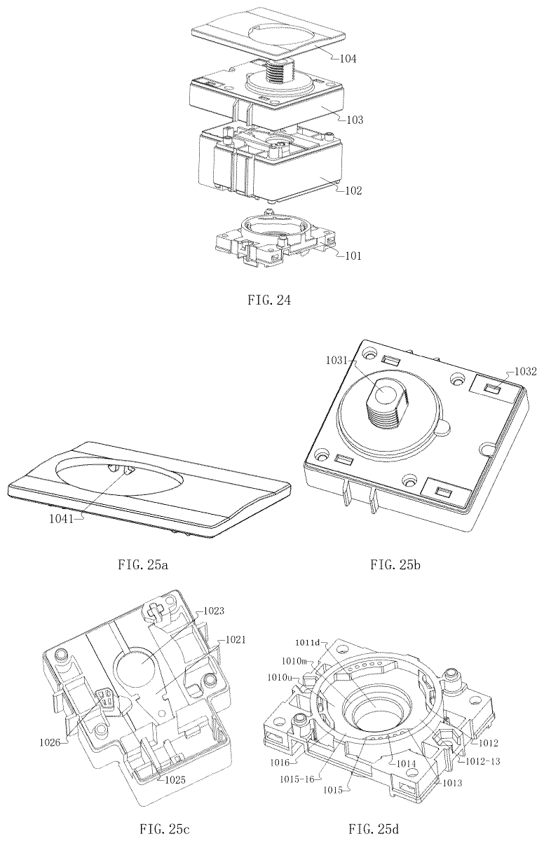

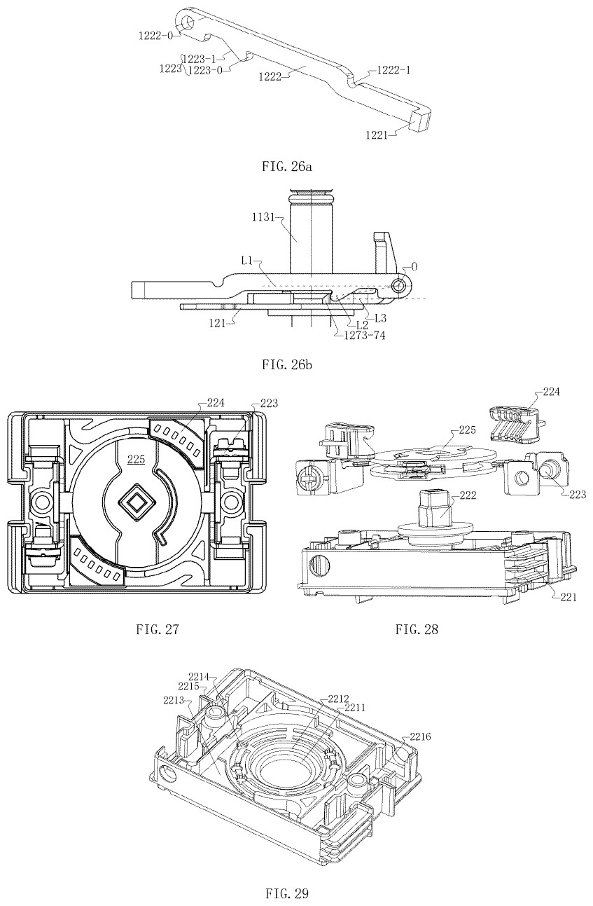

Preferably, as shown in FIGS. 23-24, the device housing further includes a housing panel 104. The housing panel 104 and the housing partition plate 102 are respectively located at two sides of the upper housing cover 103. The housing panel 104 is fixedly connected to the upper housing cover 103. Further, as shown in FIG. 25a, a panel clamping foot 1041 is arranged on one side of the housing panel 104 facing the upper housing cover 103. As shown in FIG. 25b, an upper cover camping hole 1032 is formed on one side of the upper housing cover 103 facing the housing panel 104. The panel clamping foot 1041 is clamped in the upper cover clamping hole 1032.

Preferably, as shown in FIGS. 24 and 25a, an arc-shaped protrusion surface with a cross-section as an arc line is arranged on one side of the housing panel 104 away from the upper housing cover 103, and two ends of the arc-shaped protrusion surface in a length direction are respectively flush with two ends of the housing panel 104. An upper cover shaft column base is also arranged on one side of the upper housing cover 103 facing the housing panel 104. An upper cover shaft column is arranged on the upper cover shaft column base. A panel opening that allows the upper cover shaft column base to pass through and cooperates with the upper cover shaft column base is formed in the middle of the arc-shaped protrusion surface.

As another embodiment, the housing panel 104 may also be connected to the upper housing cover 103 by means of screws, ultrasonic riveting, hot riveting, etc.

As shown in FIGS. 4-6, 19a-19b, and 23-24, the locking mechanism is preferably arranged in the first space s1.

Preferably, as shown in FIG. 23, the device housing further includes a third space s3 for accommodating the tripping mechanism. The third space s3 and the second space s2 are arranged side by side in a radial direction of the operating shaft 1131.

As shown in FIGS. 1-2, and 32-33, the operating device 1 further includes a handle 4, wherein one end of the operating shaft 1131 away from the real-time energy storage mechanism is an operating shaft connecting end for plug-in connection with the handle 4.

As shown in FIG. 12, the operating shaft connecting end is provided with two operating shaft limiting surfaces 11313, and the two operating shaft limiting surfaces 11313 are both parallel to an axial direction of the operating shaft 1131. On a cross-section of the operating shaft 1131, the two operating shaft limiting surfaces 11313 are distributed in a shape of Chinese character eight; a handle connecting hole 41 is formed in the middle of the handle 4; and a shape of the handle connecting hole 41 is matched with the operating shaft connecting end. Further, the two operating shaft limiting surfaces 11313 are symmetrically arranged on two sides of an axial section of the operating shaft 1131.

As shown in FIG. 32, the operating device 1 further includes a handle connecting screw 5. The handle connecting screw 5 passes through the handle 4 in an axial direction of the operating shaft 1131, and is in threaded connection with an operating shaft screw hole 11315 in the operating shaft connecting end, which improves the connection reliability of the handle 4 and the operating shaft 1131.

As shown in FIGS. 10-18, as an embodiment of the real-time energy storage mechanism, when the operating shaft 1131 rotates between the closing position and the opening position to complete the closing and opening operations through the real-time energy storage mechanism, the real-time energy storage mechanism undergoes a process of energy storage first and then energy release. When the real-time energy storage mechanism stores energy, the switch body 2 preferably does not actuate; and when the real-time energy storage mechanism releases energy, the switch body 2 is driven to be switched between the closed state and a disconnected state. Specifically, the real-time energy storage mechanism includes a second energy storage spring 1133 and an output shaft 111; the energy storage and energy release processes of the real-time energy storage mechanism are the energy storage and energy release processes of the second energy storage spring 1133; when the second energy storage spring 1133 stores energy, the output shaft 111 does not rotate; and when the second energy storage spring 1133 releases energy, the output shaft 111 is driven to rotate, and the output shaft 111 drives the switch body 2, such that the circuit is closed or disconnected.

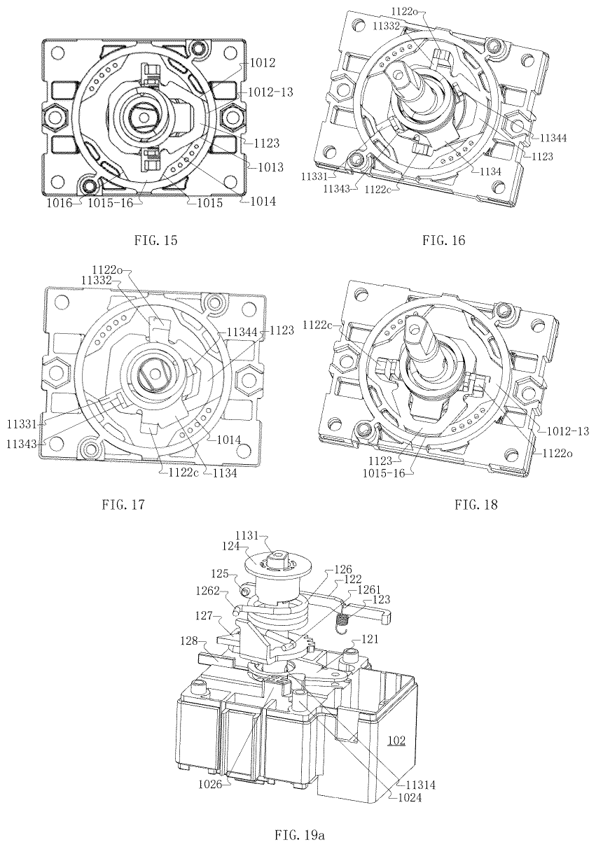

As shown in FIGS. 10-14, the real-time energy storage mechanism includes a second energy storage spring 1133, a rotating frame 1134 fixedly connected to the operating shaft 1131, a sliding frame 112, an output shaft 111 and a housing base 101; the operating shaft 1131 drives the rotating frame 1134 to rotate relative to the sliding frame 112 till being in a limiting fit with the sliding frame 112 and makes the second energy storage spring 1133 stores energy; the sliding frame 112 has two locking positions and is in locking fit with the housing base 101 at the two locking positions respectively to prevent the sliding frame 112 from rotating; the operating shaft 1133 continues to rotate and drives the sliding frame 112 at one locking position through the rotating frame 1134 to slide relative to the housing base 101, such that the sliding frame 112 releases the locking fit from the housing base 101; the second energy storage spring 1133 releases energy and drives the sliding frame 112 to rotate and slide into the other locking position; and meanwhile, the sliding frame 112 drives the output shaft 111 to rotate. Further, the output shaft 111 is rotatably arranged on the housing base 101 around its own axis. The sliding frame 112 is arranged rotatably in synchronization with the output shaft 111, and the sliding frame 112 is slidably arranged relative to the housing base 101 and the output shaft 111; the housing base 101 includes two limiting grooves distributed at intervals in a rotation direction of the output shaft 111, which are respectively an opening groove 1012-13 and a closing groove 1015-16; the sliding frame 112 is in a limiting fit with one limiting groove at one locking position; the operating shaft 1131 drives the rotating frame 1134 to rotate relative to the sliding frame 112 till the rotating frame 1134 gets to be in a limiting fit with the sliding frame 112, and meanwhile drives the second energy storage spring 1133 to store energy; the operating shaft 1131 continues to rotate and drives the sliding frame 112 to slide relative to the housing base 101 through the rotating frame 1134, such that the sliding frame 112 slides out of this limiting groove; the second energy storage spring 1133 releases energy to drive the sliding frame 112 to rotate and slide into the other limiting groove, so that the sliding frame 112 reaches the other locking position; and meanwhile the sliding frame 112 drives the output shaft 111 to rotate, and the output shaft 111 drives the switch body 2, such that the circuit is connected or disconnected. Further, the operating shaft 1131 rotates between the closing position and the opening position, such that the sliding frame 112 is switched between the two limiting grooves. Specifically, as shown in FIG. 15, the operating shaft 1131 is in the opening position, and the sliding frame 112 is in a limiting fit with the opening groove 1012-13; the operating shaft 1131 is driven by an external force to rotate clockwise, as shown in FIG. 16, the operating shaft 1131 drives the rotating frame 1134 to rotate relative to the sliding frame 112 and meanwhile drives the second energy storage spring 1133 to store energy until the rotating frame 1134 is in limiting fit (e.g., in contact limiting) with the sliding frame 112. As shown in FIG. 17, the operating shaft 1131 continues to rotate clockwise. The sliding frame 112 is driven by the rotating frame 1134 to slide relative to the output shaft 111 in order to escape out from the opening groove 1012-13, and the second energy storage spring 1133 begins to release energy and drives the sliding frame 112 to rotate clockwise and then slide into the closing groove 1015-16, as shown in FIG. 18. As shown in FIG. 18, the operating shaft 1131 is at the closing position, and the sliding frame 112 is in a limiting fit with the closing groove 1015-16; the operating shaft 1131 is driven by an external force to rotate anticlockwise, the operating shaft 1131 drives the rotating frame 1134 to rotate relative to the sliding frame 112, and meanwhile drives the second energy storage spring 1133 to store energy, until the rotating frame 1134 is in contact fit with the sliding frame 112; the operating shaft 1131 continues to rotate anticlockwise, and drives the sliding frame 112 through the rotating frame 1134 to slide relative to the output shaft 111 so as to escape out of the closing groove 1015-16; and the second energy storage spring 1133 begins to release energy and drives the sliding frame 112 to rotate anticlockwise and slide into the opening groove 1012-13, as shown in FIG. 15.

As shown in FIGS. 1-2, and 11-12, one end of the operating shaft 1131 is fixedly connected to the rotating frame 1134, and the other end of the operating shaft 1131 passes through the upper housing cover 103, and protrudes out of the device housing for external operation. Further, as shown in FIGS. 23 and 25b, the upper housing cover 103 includes an upper cover shaft column, and an upper cover shaft hole 1031 for the operating shaft 1131 to pass through is formed in the middle of the upper cover shaft column. Further, a seal ring 1132 is arranged on the operating shaft 1131, and a sealing ring 1132 is located between an inner side wall of the upper cover shaft hole 1031 and the operating shaft 1131. The sealing ring 1132 is conducive to reducing a friction force between the operating shaft 1131 and the upper cover shaft hole 1031, and also to sealing the upper cover shaft hole 1031. Further, the operating shaft 1131 is provided with an annular groove 11312 for accommodating the sealing ring 1132.

As shown in FIGS. 10-14, the second energy storage spring 1133 is a torsion spring and is rotatably sleeved onto the operating shaft 1131. Further, the second energy storage spring 1133, the rotating frame 1134, the output shaft 111 and the operating shaft 1131 are coaxially arranged, and the second energy storage spring 1133, the rotating frame 1134, the sliding frame 112 and the output shaft 111 are arranged sequentially. The sliding frame 112 slides along a radial direction of the output shaft 111.

As another embodiment, the second energy storage spring 1133 may also be a spring of other forms, such as a compression spring, and two compression springs are symmetrically arranged at two radial ends of the rotating frame 1134 and are rotatably connected to the two radial ends of the rotating frame 1134 respectively. This structure can cause the volume of the real-time energy storage mechanism to increase and occupy more installation space.

As shown in FIGS. 10-12, the real-time energy storage mechanism further includes a second bushing 1135. The second bushing 1135 rotatably sleeves the operating shaft 1131 and is inserted between the second energy storage spring 1133 and the operating shaft 1131, which can effectively prevent the second energy storage spring 1133 from being locked in torsion, better fix the second energy storage spring 1133, and prevent the second energy storage spring 1133 from deflecting, thereby ensuring the reliable and stable operations of the real-time energy storage mechanism.

The second energy storage spring 1133 includes a second spring spiral body which is rotatably sleeved onto the operating shaft 1131. Two ends of the second spring spiral body are respectively flush with two ends of the second bushing 1135 or are located between two ends of the second bushing 1135, so that the second energy storage spring 1133 and the operating shaft 1131 are spaced to the greatest extent, thereby avoiding the second energy storage spring 1133 and the operating shaft 1131 from being locked, and ensuring reliable operations of the real-time energy storage mechanism. Specifically, one end of the second bushing 1135 abuts against the rotating frame 1134, and the other end of the second bushing 1135 abuts against a limiting table surface on the operating shaft 1131. One end of the second bushing 1135 and one end of the second energy storage spring spiral body of the second energy storage spring 1133 abut against the rotating frame 1134 respectively, and the other end of the second bushing 1135 protrudes out of or is flush with the other end of the second energy storage spring spiral body.

As shown in FIGS. 10-12, the rotating frame 1134 is of a U-shaped structure, and includes a rotating frame bottom plate 11340 and two opposite rotating frame arms. As shown in FIGS. 10-14, the sliding frame 112 is of a U-shaped structure, and includes a sliding frame bottom plate 1120 and two opposite sliding frame arms. As shown in FIGS. 10-12, the two rotating frame arms are located between the two sliding frame arms. The second energy storage spring 1133 includes a second spring spiral body, and two second spring elastic arms connected to the second spring spiral body respectively. The two second spring elastic arms are preferably located on the same plane. The rotating frame arms and the sliding frame arms are located on the same side of a connection line between the two second spring elastic arms. One rotating frame arm and one sliding frame arm are located side by side on one radial side of the operating shaft 1131 and cooperate with one second spring elastic arm of the second energy storage spring 1133, and the other rotating frame arm and the other sliding frame arm are located on the other radial side of the operating shaft 1131 and cooperate with the other second spring elastic arm of the second energy storage spring 1133. The second energy storage spring 1133 exerts an acting force to the sliding frame 112 to prevent the sliding frame from escaping out of the limiting groove. Specifically, as shown in FIGS. 10-12, the two rotating arm arms of the rotating frame 1134 are respectively a closed rotating frame arm 11343 and an opened rotating frame arm 11344. As shown in FIGS. 10-11, and 13, the two sliding arm arms of the sliding frame 112 are respectively a closed sliding frame arm 1122c and an opened sliding frame arm 11220. As shown in FIG. 12, two ends of the second energy storage spring 1133 are respectively a second spring first-end 11331 and a second spring second-end 11332. As shown in FIGS. 10-11, 14, and 18, the second spring first-end 11331 and the second spring second-end 11332 are located on the same side of the rotating frame arm and the sliding frame arm, the second spring first-end 11331 cooperates with the closed rotating frame arm 11343 and the closed sliding frame arm 1122c which are arranged side by side, and the second spring second-end 11332 cooperates with the opened rotating frame arm 11344 and the opened sliding frame arm 11220 which are arranged side by side. As shown in FIGS. 15-18, when the operating shaft 1131 rotates (preferably clockwise) from the opening position to the closing position, the operating shaft 1131 drives the rotating frame 1134 to rotate, and the closed rotating frame arm 11343 abuts against the second spring first-end 11331, such that the second energy storage spring 1133 twists for energy storage until the rotating frame 1134 is in contact with the closed sliding frame arm 1122c of the sliding frame 112; and meanwhile, the opened rotating frame arm 11344 moves away from the second spring second-end 11332, the operating shaft 1131 continues to rotate and drives the sliding frame 112 through the rotating frame 1134 to slide relative to the output shaft 111 so as to escape out of the opening groove 1012-13, the second energy storage spring 1133 begins to release energy, and the second spring second-end 11332 abuts against the opened sliding frame arm 11220, such that the sliding frame 112 rotates until the sliding frame 112 slides into the closing groove 1015-16; and the second spring second-end 11332 then cooperates with the opened rotating frame arm 11344, the sliding frame 112 drives the output shaft 111 to rotate at the same time, and the output shaft 111 drives the switch body 2, such that the circuit is connected. As shown in FIGS. 18 and 15, when the operating shaft 1131 rotates (preferably, anticlockwise) from the closing position to the opening position, the operating shaft 1131 drives the rotating frame 1134 to rotate, and the opened rotating frame arm 11344 abuts against the second spring second-end 1132, such that the second energy storage spring 1133 twists for energy storage until the rotating frame 1134 is in contact with the opened sliding frame arm 11220 of the sliding frame 112; meanwhile, the closed rotating frame arm 11343 moves away from the second spring first-end 11331, and the operating shaft 113 continues to rotate and drives the sliding frame 112 through the rotating frame 1134 to slide relative to the output shaft 111 so as to escape out from the closing groove 1015-16; the second energy storage spring 1133 begins to release energy, and the second spring first-end 11331 abuts against the closed sliding frame arm 1122c, such that the sliding frame 112 rotates until the sliding frame 112 slides into the opening groove 1012-13; and the second spring first-end 11331 cooperates again with the closed rotating frame arm 11343, the sliding frame 112 drives the output shaft 111 to rotate at the same time, and the output shaft 111 drives the switch body 2, such that the circuit is disconnected.

As shown in FIGS. 10-12, and 15-18, a rotating frame driving part is arranged at one end of the rotating frame bottom plate 11340 of the rotating frame 1134, the rotating frame driving part abuts against the sliding frame arm of the sliding frame 112 to drive the sliding frame 112 to slide relative to the housing base 101 so as to escape out from the limiting groove of the housing base 101.

As shown in FIGS. 15-18, the housing base 101 further includes a transition arc surface 1014, wherein two ends of the transition arc surface 1014 are connected to the opening groove 1012-13 and the closing groove 1015-16 respectively, and the sliding frame 112 slides through the transition are surface 1014 to be switched between the opening groove 1012-13 and the closing groove 1015-16. Further, as shown in FIGS. 13-18, the sliding frame bottom plate 1120 of the sliding frame 112 includes a sliding frame limiting end 1123 arranged at one end thereof, and an end surface of the sliding frame limiting end 1123 is a sliding frame arc surface matched with the transition arc surface 1014, thereby ensuring that the sliding frame 112 slides smoothly into the corresponding limiting groove.

As shown in FIGS. 15-18, the opening groove 1012-13 includes a first opening groove side surface 1012 and a second opening groove side surface 1013 which are arranged oppositely at intervals. The closing groove 1015-16 includes a first closing groove side surface 1015 and a second closing groove side surface 1016 which are arranged oppositely at intervals. One ends of the second opening groove side surface 1013 and the first closing groove side surface 1015 are respectively connected to two ends of the transition arc surface 1014. The second opening groove side surface 1013 and the first closing groove side surface 1015 are symmetrically arranged and distributed in a shape of Chinese character eight. The spacing between one end of the second opening groove side surface 1013 and one end of the first closing groove side surface 1015, which are connected to the transition arc surface 1014, is less than the spacing between the other end of the second opening groove side surface 1013 and the other end of the first closing groove side surface 1015. Further, the first opening groove side surface 1012 and the second opening groove side surface 1013 are symmetrically arranged; and the first closing groove side surface 1015 and the second closing groove side surface 1016 are symmetrically arranged.

As shown in FIG. 13, the sliding frame bottom plate 1120 is provided with a sliding frame chute 1124. The output shaft 111 includes an output shaft driven part 1110, and a sliding boss 1112 is arranged on one side of the output shaft driven part 1110 facing the sliding frame bottom plate 1120. The width of the sliding frame chute 1124 is matched with the width of the sliding boss 1112, and the length of the sliding frame chute 1124 is greater than the length of the sliding boss 1112. The sliding frame bottom plate 1120 slidably sleeves the sliding boss 1112 through the sliding frame chute 1124 and is slidably arranged on the output shaft driven part 1110. The sliding frame bottom plate 1120 slides along the radial direction of the output shaft 111.

As shown in FIG. 13, the output shaft 111 further includes an output shaft positioning hole 1113. As shown in FIG. 12, one end of the operating shaft 1131 close to the output shaft 111 is rotatably inserted into the output shaft positioning hole 1113. The output shaft positioning hole 1113 cooperates with the operating shaft to ensure that the output shaft 111 is coaxial with the operating shaft 1131. Further, as shown in FIG. 13, the output shaft positioning hole 1113 includes a first hole segment and a second hole segment that are coaxially arranged and communicated with each other, wherein the first hole segment has an inner diameter greater than an inner diameter of the second hole segment. As shown in FIG. 12, the operating shaft 1131 includes an operating shaft positioning column 11311 arranged at one end thereof facing the output shaft 111, wherein the operating shaft positioning column 11311 has an outer diameter smaller than the outer diameter of the operating shaft 1131, the operating shaft positioning column 11311 is rotatably inserted into the second hole segment after passing through the first hole segment, and the operating shaft 1131 is rotatably inserted into the first hole segment.

As shown in FIG. 14, the output shaft 111 further includes an output shaft driving part 1111, wherein one end of the output shaft driving part 111 is coaxially connected to the output shaft driven part 1110, and a driving part connecting hole 1114 is formed in the other end of the output shaft driving part 111 and used for being in driving connection with the moving contact assembly of each switch unit of the switch body 2. Further, the driving part connecting hole 1114 includes a square counterbore, and cylindrical counterbores that are respectively formed in four apexes of the square counterbore, and the cylindrical counterbores are communicated with the square counterbore.

As shown in FIG. 25d, the upper cover base 101 is provided with a base assembling groove 1010u, a base counterbore 1010m and a base shaft hole 1011d which are arranged sequentially. The opening groove 1012-13 and the closing groove 1015-16 are both formed in the base assembling groove 1010u. The sliding frame 112 is slidably arranged in the base assembling groove 1010u. The base counterbore 1010m is coaxial with the base shaft hole 1011d. The output shaft driven part 1110 and the output shaft driving part 111 of the output shaft 111 are rotatably arranged in the base counterbore 1010m and the base shaft hole 1011d respectively.

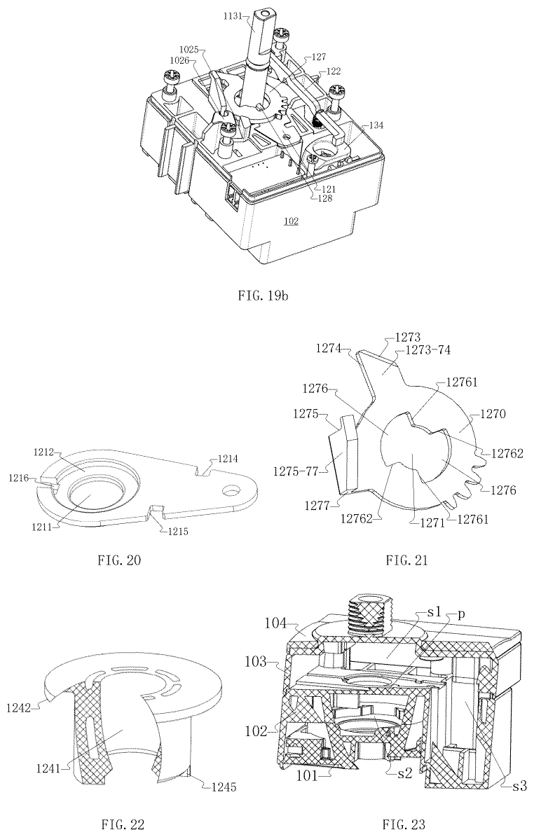

As shown in FIGS. 4-7, and 19a-22, as an embodiment of the delayed energy storage mechanism, the delayed energy storage mechanism is used for providing energy to the opening operation of the operating device, that is, the delayed energy storage mechanism provides the operating shaft 1131 a driving force that drives the operating shaft to rotate from the closing position to the opening position. Specifically, the delayed energy storage mechanism includes a first energy storage spring 126; when the operating shaft 1131 rotates from the opening position to the closing position to drive the operating device to be closed, the first energy storage spring 126 is driven to store energy, that is, the delayed energy storage mechanism is driven to be switched from the energy-release state to the energy-storage state; and in the course of remote opening control, the delayed energy storage mechanism releases energy, that is, the first energy storage spring 126 releases energy, and provides the operating shaft 1131 a driving force for driving the operating shaft 1131 to rotate from the closing position to the opening position.

When the operating device 1 is in the closed state, the delayed energy storage mechanism releases energy to drive the operating shaft 1131 to rotate, and then the operating shaft 1131 drives the operating device 1 to be switched to the opened state through the real-time energy storage mechanism. A transmission path when the delayed energy storage mechanism drives the operating device 1 to be opened is as follows: the delayed energy storage mechanism→the operating shaft 1131→real-time energy storage mechanism. Compared with a delayed energy storage mechanism in the prior art which directly drives the opening operation through the real-time energy storage mechanism, the overall structure of the operating device is simplified, and the working stability and reliability are improved. The rotary disconnecting switch in this embodiment, regardless of being manually operated or remotely controlled, needs to output an opening or closing operation force through the operating shaft 1131, and completes the opening operation or closing operation through the real-time energy storage mechanism.

As shown in FIGS. 7 and 19a, the delayed energy storage mechanism includes a turntable 127 and a first energy storage spring 126. The turntable 127 is driven by the operating shaft 1131 to rotate from the energy-release position to the energy-storage position, such that the first energy storage spring 126 stores energy. In addition, when the turntable 127 is locked in the energy-storage position, the delayed energy storage mechanism is kept in the energy-storage state. When the operating shaft 1131 is in the closing position, that is, the operating device 1 in the closed state, there is an opening idle stroke between the turntable 127 and the operating shaft 1131. The operating shaft 1131 is driven by an external force to rotate. The operating shaft 1131 rotates from the closing position to the opening position, such that the operating device 1 is switched to the opened state, and also passes by the opening idle stroke relative to the turntable 127. Further, as shown in FIGS. 6-7, the turntable 127 is in locking fit with the locking fastener 122 of the locking mechanism, and the turntable 127 is locked in the energy-storage position.

As shown in FIGS. 4-9 and 19a-19b, the turntable 127 is coaxial with the operating shaft 1131. The turntable 127 includes a turntable main board 1270. The turntable main board 1270 is provided with a turntable shaft hole 1271 and at least one turntable driven hole 1276. The turntable 127 rotatably sleeves the operating shaft 1131 through the turntable shaft hole 1271. The turntable driven hole 1276 includes a first surface 12761 and a second surface 12762. The delayed energy storage mechanism includes a driving finger which is fixedly arranged on the operating shaft 1131 and rotates in synchronization with the operating shaft, and the driving finger is arranged in the turntable driven hole 1276. The driving finger abuts against the first surface 12761, such that the turntable 127 rotates toward the energy-storage position. As shown in FIG. 19b, when the operating shaft 1131 is in the closing position, there is an opening idle stroke between the second surface 12762 and the driving finger. The opening idle stroke is preferably a sector-shaped avoidance corner between the driving finger and the second surface 12762. At this moment, the operating shaft 1131 rotates from the closing position to the opening position, and the operating shaft 1131 drives the driving finger to pass by the opening idle stroke relative to the turntable 127, and the driving finger may also rotate by this sector-shaped avoidance corner relative to the second surface 12762. Meanwhile, a closing idle stroke is formed between the driving finger and the first surface 12761, at this moment, the operating shaft 1131 rotates from the opening position to the closing position, and the operating shaft 1131 then drives the driving finger to pass by the closing idle stroke relative to the turntable 127. An opening idle stroke is formed again between the driving finger and the second surface 12762, that is, the delayed energy storage mechanism is in the energy-storage state (the turntable 127 is at the energy-storage position), and the operating shaft 1131 can rotate freely between the closing position and the opening position relative to the turntable 127, without affecting the state of the delayed energy storage mechanism, that is, the delayed energy storage mechanism will remain in the energy-storage state. When the delay energy storage mechanism releases energy, the first energy storage spring 126 releases energy to drive the turntable 127 to rotate to the energy-release position, the first surface 12761 cooperates with the driving finger, and the operation shaft 1131 is driven to rotate to the opening position. The operating shaft 1131 preferably drives the operating device 1 to be switched to the opened state through the real-time energy storage mechanism. When the operating shaft 1131 drives the delayed energy storage mechanism to store energy, the driving finger presses against the first surface 12761, and drives the turntable 127 to rotate from the energy-release position to the energy-storage position. When the delayed energy storage mechanism releases energy, the turntable 127 rotates from the energy-storage position to the energy-release position and presses against the driving finger through the first surface 12761, and the driving finger drives the operating shaft 1131 to rotate from the closing position to the opening position.

As shown in FIG. 21, the turntable driven hole 1276 is a sector-shaped hole concentric with the turntable shaft hole 1271, and the first surface 12761 and the second surface 12672 are respectively arranged at two ends of the sector-shaped hole in a circumferential direction. Further, the turntable 127 includes two sector-shaped holes, which are symmetrically formed on two radial sides of the turntable shaft hole 1271. The delayed energy storage mechanism further includes a driving key 128. The driving key 128 is inserted onto the operating shaft 1131 in a radial direction, and two ends of the driving key 128 respectively protrude out of the two radial sides of the operating shaft 1131 as driving fingers, and are respectively arranged in the two sector-shaped holes. Further, the radial inner ends of the two sector-shaped holes are communicated with the turntable shaft hole 1271 respectively, three of which are integrally formed into a dumbbell-shaped structure. As shown in FIGS. 12, and 19a-19b, the operating shaft 1131 is provided with an operating shaft jack 11314 for the driving member 128 to insert.

As another embodiment, the opening idle stroke between the turntable 127 and the operating shaft 1131 can also be realized in the following ways. Specifically, the operating shaft 1131 is provided with a sector-shaped groove, wherein a circle center of the sector-shaped groove coincides with an axis of the operating shaft 1131, and two ends of the sector-shaped groove in a circumferential direction are respectively two driving surfaces, which are a first driving surface and a second driving surface respectively; the turntable 127 includes a turntable driven finger arranged in the turntable shaft hole 1271, and the turntable driven finger is inserted in the sector-shaped groove; when the operating shaft 1131 rotates from the opening position to the closing position, the first driving surface presses against the turntable driven finger, such that the turntable 127 rotates from the energy-release position to the energy-storage position, and the turntable 127 is locked in the energy-storage position; there is an opening idle stroke between the second driving surface and the turntable driven finger, and at this moment, when the operating shaft 1131 rotates from the closing position to the opening position, the operating shaft 1131 passes by the opening idle stroke relative to the turntable 127; there is a closing idle stroke between the second driving surface and the turntable driven finger, and at this moment, when the operating shaft 1131 rotates from the opening position to the closing position, the operating shaft 1131 passes by the closing idle stroke relative to the turntable driven finger. That is, when the delayed energy storage mechanism is in the energy-storage state (the turntable 127 is located in the energy-storage position), the operating shaft 1131 can freely rotate between the closing position and the opening position to drive the operating device to be switched between the closed state and the opening state.

As shown in FIGS. 4-9, and 19a-19b, the first energy storage spring 126 is a torsion spring that rotatably sleeves the operating shaft 1131. The first energy storage spring 126, the turntable 127 and the operating shaft 1131 are coaxially arranged. Two ends of the first energy storage spring 126 are respectively a first spring fixed end 1261 that is fixedly arranged and a first spring driven end 1262 that cooperates with the turntable 127. The turntable 127 rotates toward the energy-storage position and drives the first spring driven end 1262 to swing, such that the first energy storage spring 126 twists for energy storage. Further, the first energy storage spring 126 includes a first spring spiral body, a first spring fixed end 1261 and a first spring driven end 1262, wherein the first spring fixed end 1261 and the first spring driven end 1262 are respectively connected to two ends of the first spring spiral body.

As another embodiment, the first energy storage spring 126 is a linear compression spring, wherein one end of the first energy storage spring is rotatably arranged on the housing partition plate 102 of the device housing, and the other end of the first energy storage spring is rotatably connected to the turntable 127. The turntable 127 rotates from the energy-release position to the energy-storage position, so that the first energy storage spring 126 is compressed for energy storage, and the energy-storage position of the turntable 127 is in front of a dead center position of the first energy storage spring 126. The dead center position of the first energy storage spring 126 refers to a position of the first energy storage spring 126 when a geometric axis of the first energy storage spring 126 is located in the same straight line as the axis of the turntable 127. Of course, the first energy storage spring 126 may also be replaced with a torsion spring, and two ends of the torsion spring are respectively rotatably connected to the housing partition plate 102 and the turntable 127. At this time, the dead center position of the first energy storage spring 126 refers to the position of the first energy storage spring 126 when two ends of the torsion spring are located in the same straight line as the turntable 127. The above implementation method will increase the occupied space of the delayed energy storage mechanism, so the torsion spring that rotatably sleeves the operating shaft 1131 is preferably adopted as the first energy storage spring 126 in the present embodiment.

As shown in FIGS. 4-6, 19a-19b, and 21, the turntable 127 includes a turntable main board 1270 and a turntable cooperation arm 1275-77. One end of the first spring fixed end 1261 of the first energy storage spring 126 is fixed on the device housing. The first spring driven end 1262 cooperates with the turntable cooperation arm 1275-77. The turntable 127 pushes the first spring driven end 1262 to swing through the turntable cooperation arm 1275-77, such that the first energy storage spring 126 twists for energy storage. Further, the turntable 127 is rotatably arranged on the housing partition plate 102 of the device housing. The housing partition plate 102 is provided with a turntable stopper 1026 and a housing partition plate spring limiting groove 1025. The first spring fixed end 1261 is fixed in the housing partition plate spring limiting groove 1025. The turntable stopper 1026 is in a limiting fit with the turntable cooperation arm 1275-77, such that the turntable 127 is limited in the energy-release position. Further, the housing partition plate spring limiting groove 1025 is formed in the turntable stopper 1026. The turntable cooperation arm 1275-77 includes a turntable cooperation arm limiting side edge 1277 and a turntable cooperation arm cooperation side edge 1275 which are arranged oppositely. The turntable cooperation arm limiting side edge 1277 cooperates with the turntable stopper 1026. The turntable cooperation arm cooperation side edge 1275 cooperates with the first spring driven end 1262.

Preferably, as shown in FIG. 19a-21, the turntable cooperation arm 1275-77 is connected with a plane, where the turntable main board 1270 is located, in a bending manner. Further, the turntable cooperation arm 1275-77 is perpendicular to the turntable main board 1270.

As shown in FIGS. 4-9, and 19a-19b, the delayed energy storage mechanism further includes a first bushing 124. The first bushing 124 rotatably sleeves the operating shaft 1131 and is inserted between the first energy storage spring 126 and the operating shaft 1131, which can prevent the first energy storage spring 126 from locking the operating shaft 1131 while twisting for energy storage, better fix the first energy storage spring 126 and prevent the first energy storage spring 126 from deflecting, thereby ensuring the reliable and stable work of the delayed energy storage mechanism. One end of the first bushing 124 abuts against the turntable 127, such that the turntable 127 is limited between the first bushing 124 and the housing partition plate 102, and the turntable 127 is kept in a horizontal state (that is, a state perpendicular to an axial direction of the operating shaft 1131), thereby preventing the turntable 127 having a warping tendency under the action of a torsional torque of the first energy storage spring 126.

As shown in FIGS. 7, and 19a-20, the delayed energy storage mechanism further includes a gasket 121 arranged on the housing partition plate 102 of the device housing. As shown in FIGS. 19a-19b, and 23-24, the first bushing 124 includes a first bushing head 1242 and a first bushing body 1241 which are coaxially arranged and connected to each other. The first bushing head 1242 has an outer diameter greater than the outer diameter of the first bushing body 1241 and greater than the outer diameter of the first spring spiral body of the first energy storage spring 126. The first bushing body 1241 is inserted between the first spring spiral body and the operating shaft 1131. The gasket 121 is arranged on the housing partition plate 102. The first energy storage spring 126, the turntable 127 and the gasket 121 are sequentially arranged between the upper housing cover 103 and the housing partition plate 102. The first bushing head 1242 cooperates with the upper housing cover 103 to limit the first bushing 124 from moving along an axial direction of the operating shaft 1131. The first spring spiral body is located between the first bushing head 1242 and the turntable 127. The turntable 127 is rotatably arranged on the gasket 121. The gasket 121 forms protection to the housing partition plate 102, so as to avoid the turntable 127 from rotating and wearing the housing partition plate 102, which is conducive to prolonging the service life. Further, one end of the first bushing body 1241 is connected to the first bushing head 1242, a plurality of sliding protrusions 1245 is arranged at the other end of the first bushing body 1241, and the sliding protrusions 1245 abut against the turntable 127, which is conducive to reducing a sliding resistance between the first bushing 124 and the turntable 127. In addition, the sliding protrusions 1245 can also carry out plane limiting on the warping tendency generated by the turntable 127 under the effect of an eccentric torque of the energy storage spring 126. The turntable main board 1270 of the turntable 127 is kept in a horizontal state, thereby ensuring that a turntable locking arm latching surface 1274 is kept in a horizontal state to maintain a limiting fit with a locking fastener latching surface 1223-0 of the locking fastener 122 in a horizontal direction. The plurality of sliding protrusions 1245 is preferably evenly distributed on a free end of the first bushing body 1241 in a circumferential direction of the first bushing body 1241.

As shown in FIGS. 19a-19b, and 21, the gasket 121 is provided with a gasket avoidance hole 1211 for the operating shaft 1131 to pass through, a gasket counterbore 1212 formed in one side of the gasket 121 facing the turntable 127, and a gasket opening 1216 for the driving key 128 of the delayed energy storage mechanism to pass through. The gasket counterbore 1212 has an internal diameter greater than an inner diameter of the gasket avoidance hole 1211 and less than an outer diameter of the turntable main board 1270 of the turntable 127. The gasket opening 1216 is communicated with the gasket counterbore 1212. The driving key 128 enters the gasket counterbore 1212 through the gasket opening 1216, is inserted onto the operating shaft 1131, and swings in the gasket counterbore 1212. When the operating device is assembled, the operating shaft 1131 is assembled together with the real-time energy storage mechanism at first, the delayed energy storage mechanism is then assembled, and the gasket opening 1216 is convenient for the assembly of the driving key 128 and the operating shaft 1131, so the assembly efficiency is improved. Further, the gasket 121 further includes a first gasket clamping groove 1214 and a second gasket clamping groove 1215. The two gasket clamping grooves are respectively formed in two opposite sides of the gasket 121, and are respectively in clamping fit with the housing partition plate 102 of the device housing.

As shown in FIG. 25c, the housing partition plate 102 is provided with a gasket mounting groove 1021. A bottom wall of the gasket mounting groove 1021 is provided with a partition plate shaft hole 1023 for the operating shaft 1131 to pass through. Two partition plate clamping platforms, i.e., a first partition clamping platform and a second partitioning clamping platform, that cooperate with the first gasket clamping groove 1214 and the second gasket clamping groove 1215 are arranged in the gasket mounting groove 1021 respectively.

As shown in FIGS. 4-7, 19a-19b, and 26a, the locking fastener 122 of the locking mechanism is rotatably arranged, and includes a locking fastener main board 1222 and a locking fastener locking part 1223. The turntable 127 further includes a turntable locking arm 1273-74 (as an external structure that is in a limiting fit with the locking fastener locking part 1223 of the locking fastener 122) arranged on the turntable main board 1270. In the process of rotating the turntable 127 from the energy-release position to the energy-storage position (that is, in a process that the turntable 127 drives the first energy storage spring 126 to store energy), the turntable locking arm 1273-74 abuts against the locking fastener locking part 1223, such that the locking fastener 122 rotates in the first direction to avoid the turntable locking arm 1273-74. After the turntable locking arm 1273-74 crosses the locking fastener locking part 1223, the locking fastener 122 rotates in the second direction to reset and is in a limiting fit with the turntable locking arm 1273-74, and the turntable 127 is limited in the energy-storage position, so that the delayed energy storage mechanism is kept in the energy-storage state. The first direction and the second direction are opposite directions to each other. The locking fastener 122 rotates to the first direction (unlocking direction) to avoid the turntable locking arm 1273-74, so that the turntable locking arm 1273-74 and the locking fastener locking part 1223 are unlocked, and the first energy storage spring 126 releases energy to drive the turntable 127 to rotate from the energy-storage position to the energy-release position. Further, the latch fastener locking part 1223 is arranged on a side edge of the locking fastener main board 1222 facing the turntable 127.

As shown in FIGS. 7 and 26a-26b, one end of the locking fastener 122 is a locking fastener pivoting end, and the other end of the locking fastener 122 is a locking fastener driven part 1221. The locking fastener 122 is rotatably arranged through the locking fastener pivoting end. The locking fastener 122 is driven by an external force (e.g., the trip 134 of the tripping mechanism) through the locking fastener driven part 1221 to rotate in the unlocking direction, so that the locking fastener locking part 1223 releases locking fit from the turntable locking arm 1273-74. Further, the locking fastener driven part 1221 is connected with the locking fastener main board 1222 in a bending manner, and a plane where the locking fastener driven part 1221 is located intersects with a plane where the locking fastener main board 1222 is located. Further, the plane where the locking fastener driven part 1221 is perpendicular to the plane where the locking fastener main board 1222 is located, and one end of the locking fastener main board 1222 which is connected with the locking fastener driven part 1221 is flush with a side edge of the locking fastener driven part 1221.

As shown in FIGS. 26a-26b, the locking fastener pivoting end is provided with a locking fastener shaft hole 1222-0. As shown in FIGS. 4-7, and 19a-19b, the locking mechanism further includes a locking fastener shaft 125 fixed on the housing partition plate 102 of the device housing. The locking fastener 122 is rotatably arranged on the locking fastener shaft 125 through the locking fastener shaft hole 1222-0.

As shown in FIGS. 26a-26b, the locking fastener locking part 1223 includes a locking fastener latching surface 1223-0, wherein the locking fastener latching surface 1223-0 is located at one side of a straight line L1 that extends in an extension direction of the locking fastener main board 1222 and passes through a rotating center O of the locking fastener 122. Specifically, as shown in FIG. 26b, when the locking fastener 122 is in a horizontal state, the locking fastener latching surface 1223-0 is located below the straight line L1, and an external structure is engaged with the locking fastener latching surface 1223-0 from one side of the locking fastener latching surface 1223-0 and exerts an acting force parallel to the straight line L1 to the locking fastener latching surface 1223-0, so that the locking fastener 122 rotates in the locking direction. The locking direction and the unlocking direction are opposite to each other.

As shown in FIG. 26b, a connecting line between the rotating center O of the locking fastener 122 and a contact point of the turntable locking arm 1273-74 and the locking fastener latching surface 1223-0 is a straight line L2. The acting force exerted by the turntable locking arm 1273-74 to the locking part latching surface 1223-0 extends in a direction of a straight line L3, the straight line L3 is located below the straight line L2, and the straight line L2 is located below the straight line L1.

Preferably, as shown in FIGS. 7, and 26a-26b, the locking fastener locking part 1223 includes a locking part guide surface 1223-1 and a locking part latching surface 1223-0, wherein the turntable locking arm 1273-74 presses against the locking part guide surface 1223-1, such that the locking fastener 122 rotates in the first direction, and the turntable locking arm 1273-74 is in a limiting fit with the locking part latching surface 1223-0, such that the turntable 127 is locked in the energy-storage position. Further, the locking fastener locking part 1223 and the locking fastener main board 1222 are coplanar. The locking fastener locking part 1223 is arranged on a side edge of the locking fastener main board 1222 facing the turntable main board 1270. The locking fastener locking part 1223 is of a wedge-shaped structure, and has a large-diameter end connected to the locking fastener main board 1222, and a tip end facing the turntable main board 1270.

Preferably, as shown in FIG. 21, a rotating plane of the turntable main board 1270 is perpendicular to the operating shaft 1131, a plane where the turntable locking arm 1273-74 is located is parallel to a plane where the turntable main board 1270 is located, and the turntable locking arm 1273-74 is preferably coplanar with the turntable main board 1270. Further, the turntable locking arm 1273-74 includes a locking arm cooperation part. The locking arm cooperation part is of a right-angled plate structure, wherein one right-angle side is connected to the turntable main board 1270, and the other right-angle side is in a limiting fit with the locking part latching surface 1223-0, and a slope cooperates with the locking part guide surface 1223-1. Further, the turntable locking arm 1273-74 includes a turntable locking arm cooperation surface 1273 and a turntable locking arm latching surface 1274, wherein the turntable locking arm cooperation surface 1273 is a chamfered slope matched with the locking part guide slope 1223-1, and the turntable locking arm latching surface 1274 cooperates with the locking part latching surface 1223-0.

Preferably, as shown in FIGS. 7, and 26a-26b, the locking fastener guide surface 1223-1 is a slope, and this slope is inclined from one end close to the locking fastener pivoting end in a direction away from the locking fastener main board 1222.

As another embodiment, the locking fastener locking part 1223 is not provided with a locking part guide surface 1223-1, but the turntable locking arm 1273-74 is provided with the locking arm guide surface; and when the turntable 127 rotates from the energy-release position to the energy-storage position, the locking arm guide surface presses against a free end of the locking fastener locking part 1223, so that the locking fastener 122 rotates in the first direction to avoid the turntable locking arm 1273-74.

As shown in FIGS. 26a-26b, the locking fastener 122 is preferably of an integrated structure.

As shown in FIGS. 4-7, and 19a-19b, the locking mechanism further includes a locking fastener resetting element 123, which exerts an acting force to the locking fastener 122, such that the locking fastener 122 rotates in the second direction to reset.

The locking fastener main board 1222 includes a locking fastener resetting part 1222-1 that cooperates with the locking fastener resetting element 123. The locking fastener resetting part 1222-1 undergoes an acting force from the locking fastener resetting element 123, such that the locking fastener 122 rotates in the locking direction; and the locking fastener driven part 1221 undergoes an external force, such that the locking fastener 122 rotates in the unlocking direction. The locking direction and the unlocking direction are opposite to each other. Further, according to the directions shown in FIG. 26b, the locking direction is a counterclockwise direction, and the unlocking direction is a clockwise direction.

As shown in FIGS. 26a-26b, the locking fastener resetting part 1222-1 is arranged on a part other than the locking fastener pivoting end of the locking fastener. Further, the locking fastener resetting part 1222-1 is a main board limiting groove formed in the locking fastener main board 1222, wherein the main board limiting groove and the locking fastener locking part 1223 are respectively located on a pair of opposite side edges of the locking fastener main board 1222. Further, according to the directions as shown in FIGS. 26a and 26b, the main board limiting groove and the locking fastener locking part 1223 are respectively arranged on the upper and lower side edges of the locking fastener main board 1222.

As another embodiment, the locking fastener resetting part 1222-1 is a hole formed on the locking fastener main board 1222, or a convex rib arranged on one side or two sides of the locking fastener main board 1222.

As shown in FIGS. 4-7, and 19a-19b, the locking fastener resetting element 123 is a tension spring, wherein one end of the tension spring is connected to the housing partition plate 102 of the device housing, and the other end of the tension spring is connected to the locking fastener 122. Further, the locking fastener 122 further includes a main board limiting groove 1222-1 formed in the locking fastener main board 1222, wherein one end of the tension spring is arranged in the main board limiting groove 1222-1 in a suspension manner; and the main board limiting groove 1222-1 and the locking fastener locking part 1223 are respectively arranged on a pair of opposite side edges of the locking fastener main board 1222.

As another embodiment, the locking fastener resetting element 123 may also be a torsion spring, wherein the torsion spring sleeves on a rotating shaft (e.g., the locking fastener shaft 125) of the locking fastener 122, one end of the tension spring is fixed on the housing partition plate 102, and the other end of the tension spring cooperates with the locking fastener main board 1222.

As shown in FIGS. 26a-26b, the locking fastener main board 1222 includes a main board first-segment, a main board second-segment and a main board third-segment which are connected sequentially and coplanar. One end of the main board first-segment is the locking fastener pivoting end, and the other end of the main board first-segment is connected to one end of the main board second-segment; the other end of the main board second-segment is connected to the main board third-segment, and the other end of the main board third-segment is connected to the locking fastener driven part 1221 in a bending manner; the main board first-segment has a width greater than a width of the main board second-segment; a side edge of the main board first-segment is flush with a side edge of the main board second-segment, and the other side edge of the main board first-segment and the locking fastener locking part 1223 protrude out of the other side edge of the main board second-segment; and the main board third-segment deviates relative to the main board second-segment to a side where the locking fastener locking part 1223 is located. Further, a first avoidance groove is formed between the main board first-segment and the locking fastener locking part 1223, and the turntable locking arm 1273-74 of the turntable 127 first enters the first avoidance groove and then cooperates with the locking fastener locking part 1223; and a second avoidance groove is formed between the main board third-segment and the locking fastener locking part 1223, and the turntable locking arm 1273-74 enters the second avoidance groove after crossing the locking fastener locking part 1223. Specifically, in the directions as shown in FIGS. 26a-26b, an upper side edge of the main board first-segment is flush with an upper side edge of the main board second-segment; a lower side edge of the main board first-segment and the locking fastener locking part 1223 are arranged below a lower side edge of the main board second-segment in a protruding manner; and the main board third-segment deviates entirely downward relative to the main board second-segment.

An embodiment of the switch unit of the switch body 2 is shown in FIGS. 27-31.

As shown in FIGS. 27-28, the switch unit includes a unit housing 221, and a moving contact assembly 225, a moving contact rotating shaft 222 and static contacts 223 which are arranged in the unit housing 221. The moving contact assembly 225 includes a contact support and a moving contact arranged on the contact support. The contact support is rotatably arranged in the unit housing 221 through the moving contact rotating shaft 222; and two groups of static contacts 223 are respectively arranged on two radial sides of the moving contact assembly 225 and cooperate with two ends of the moving contact respectively. Further, the switch unit further includes an arc extinguishing chamber 224, and the two arc extinguishing chambers 224 are respectively arranged on two radial sides of the moving contact 225 and cooperate with two groups of static contacts 223 respectively.

In the switch body 2, the moving contact rotating shafts 222 of adjacent switch units are connected to each other and arranged rotatably and synchronously, thereby implementing the linkage of various switch units.

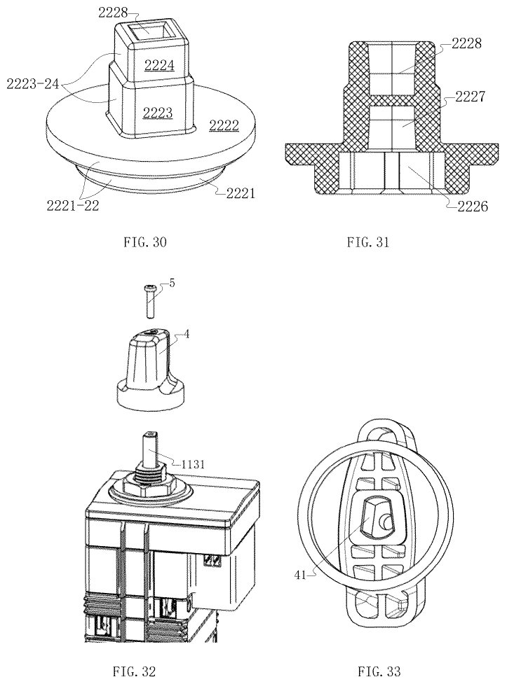

As shown in FIGS. 27-28, and 30, a support shaft hole is formed in the middle of the contact support. As shown in FIGS. 30-31, the moving contact rotating shaft 222 includes a rotating shaft base 2221-22 and a rotating shaft column 2223-24. The moving contact rotating shaft 222 is rotatably arranged in the unit housing 221 through the rotating shaft base 2221-22, is inserted in the support shaft hole through the rotating shaft column 2223-24, and is in a limiting fit with the support shaft hole, thereby implementing the synchronous rotation of the contact support and the moving contact rotating shaft 222.

As shown in FIGS. 30-31, the rotating shaft column 2223-24 includes a rotating shaft column lower-segment 2223 and a rotating shaft column upper-segment 2224, wherein one end of the rotating shaft column lower-segment 2223 is connected to the rotating shaft base 2221-22, and the other end of the rotating shaft column lower-segment is connected to the rotating shaft column upper-segment 2224; and the rotating shaft column lower-segment 2223 is inserted into the support shaft hole of the contact support, and the rotating shaft column upper-segment 2224 and the rotating shaft base 2221-22 are located on two sides of the contact support respectively. Further, the rotating shaft column lower-segment 2223 and the rotating shaft column upper-segment 2224 are coaxial with each other and are both regular quadrilateral columns; and the rotating shaft column lower-segment 2223 has a width greater than the width of the rotating shaft column upper-segment 2224.

As shown in FIGS. 30-31, the rotating shaft base 2221-22 includes a rotating shaft base upper-segment 2222 and a rotating shaft base lower-segment 2221, wherein one end of the rotating shaft base upper-segment 2222 is connected to the rotating shaft column 2223-24, and the other end of the rotating shaft base upper-segment 2222 is connected to the rotating shaft base lower-segment 2221; the rotating shaft base upper-segment 2222 and the rotating shaft base lower-segment 2221 are two cylinders which are arranged coaxially; and the rotating shaft base upper-segment 2222 has an outer diameter greater than an outer diameter of the rotating shaft base lower-segment 2221.

As shown in FIG. 29, the bottom wall of the unit housing 221 is provided with a unit housing shaft hole 2211 and a unit housing counterbore 2212 which are communicated with each other. The unit housing counterbore 2212 has an inner diameter greater than the inner diameter of the unit housing shaft hole 2211. The inner diameter of the unit housing counterbore 2212 is matched with the outer diameter of the rotating shaft base upper-segment 2222. The inner diameter of the unit housing shaft hole 2211 is matched with the outer diameter of the rotating shaft base lower-segment 2221. The rotating shaft base lower-segment 2221 passes through the unit housing counterbore 2212 and is then rotatably arranged in the unit housing shaft hole 2211. The rotating shaft base upper-segment 2222 is rotatably arranged in the unit housing counterbore 2212.

As shown in FIGS. 30-31, a rotating shaft base connecting hole 2226 is formed in the middle of the rotating shaft base 2221-22. In the switch unit 2, a free end of the rotating shaft column 2223-24 of one of two adjacent moving contact rotating shafts 222 is inserted into the rotating shaft base connecting hole 2226 of the other moving contact rotating shaft 222, thereby implementing synchronous rotation of the two moving contact rotating shafts; and a free end of the rotating shaft column 2223-24 of the moving contact rotating shaft 222 of the switch unit adjacent to the operating device 1 is inserted into the driving part connecting hole 1114 of the output shaft 111 of the real-time energy storage mechanism, thereby implementing synchronous rotation of the moving contact rotating shaft 222 and the output shaft 111.

As shown in FIG. 31, the bottom wall of the rotating shaft base connecting hole 2226 is provided with a first blind hole 2227, and a second blind hole 2228 is formed in the middle of the rotating shaft column upper-segment 2222 of the rotating shaft column 2221-22. The switch unit further includes a polygonal metal connecting shaft, wherein a cross-sectional shape of the polygonal metal connecting shaft is matched with a cross-sectional shape of the first blind hole 2227 and a cross-sectional shape of the second blind hole 2228. The two adjacent moving contact rotating shafts 222 are connected through the polygonal metal connecting shaft. One end of the metal connecting shaft is inserted into the first blind hole 2227 of the moving contact rotating shaft 222 and is in a limiting fit with the first blind hole 2227, and the other end of the metal connecting shaft is inserted into the second blind hole 2228 of the other moving contact rotating shaft 222 and is a limiting fit with the second blind hole 2228, thereby improving the rotational synchronization of the adjacent moving contact rotating shafts 222. The polygonal metal connecting shaft may be a regular polygonal metal cylinder, or may be a metal cylinder having an irregular shape.

As shown in FIG. 31, the first blind hole 2227 is located in the middle of the rotating shaft column upper-segment 2224, the second blind hole 2228 is located in the middle of the rotating shaft column lower-segment 2223, and a partition plate is arranged between the first blind hole 2227 and the second blind hole 2228.

As shown in FIG. 29, the bottom wall of the unit housing 221 is also provided with a unit housing notch 2214 in which an arc striking structure is assembled, and the unit housing notch 2214 is located on the outer side of the unit housing counterbore 2212.

As shown in FIG. 29, the unit housing 221 is further provided with a unit housing perforation 2215, and a screw rod 3 passes through each unit housing perforation 2215 and connects the respective unit housings 221 together. Further, the unit housing 221 is provided with two unit housing perforations 2215, which are respectively formed in two radial sides of the unit housing counterbore 2212.

As shown in FIG. 3, in the switch unit 2, the unit housing 221 of each switch unit is provided with an exhaust port corresponding to the arc extinguishing chamber 224, and the exhaust ports of the adjacent unit housings 221 are staggered. In the switch body 2, the switch units are divided into three types, i.e., a first intermediate switch unit 22, a second intermediate switch unit 23 and a tail switch unit 21. The first intermediate switch unit 22 and the second intermediate switch unit 23 are arranged alternately, and have the following difference in that: the exhaust ports of the unit housing 221 are arranged in different positions. The layout of various components in the unit housing 221 is adjusted accordingly. The tail switch unit 21 is located at one end of the switch body 2 away from the operating device 1. The unit housing shaft hole 2211 of the unit housing 221 of the tail switch unit 21 is a blind hole.

It should be explained that, in the description of the present invention, the terms such as “up”, “down”, “left”, “right”, “inner” and “outer” indicating the directional or positional relations on the basis of the directional or positional relations shown in the drawings are only used for conveniently describing the present invention and simplifying the description, not indicate or imply that the referred devices or elements must have a specific orientation and be configured and operated in a specific direction; therefore, they cannot be construed as a limitation on the present invention.

We have made further detailed description of the present invention mentioned above in combination with specific preferred embodiments, but it is not deemed that the specific embodiments of the present invention is only limited to these descriptions. A person skilled in the art can also, without departing from the concept of the present invention, make several simple deductions or substitutions, which all be deemed to fall within the protection scope of the present invention.

1. A remotely-controlled rotary disconnecting switch, comprising an operating device and a switch body, wherein the switch body comprises at least one switch unit, and each switch unit comprises a moving contact assembly which is arranged rotatably and a static contact which cooperates with the moving contact assembly; the operating device is in driving connection with the moving contact assembly of the switch unit and drives the moving contact assembly to rotate to be connected to or disconnected from the static contact, so that a circuit is connected or disconnected; the operating device comprises an operating shaft which is arranged rotatably around its own axis, a real-time energy storage mechanism, a delayed energy storage mechanism, a locking mechanism and a tripping mechanism; the locking mechanism comprises a locking fastener; the tripping mechanism comprises a trip; when the remotely-controlled rotary disconnecting switch is in an opened state and the delayed energy storage mechanism is in an energy-release state, the operating shaft rotates from an opening position toward a closing position and drives the operating device to be switched to a closed state through the real-time energy storage mechanism, and meanwhile drives the delayed energy storage mechanism to be switched to an energy-storage state and to be in locking fit with the locking fastener, such that the delayed energy storage mechanism is kept in the energy-storage state; when the delayed energy storage mechanism is in the energy-storage state, the operating shaft rotates freely between the opening position and the closing position, and meanwhile drives the remotely-controlled rotary disconnecting switch to be switched freely between the opened state and the closed state; and upon receiving a tripping signal, the trip actuates to drive the locking fastener to be unlocked from the delayed energy storage mechanism, then the delayed energy storage mechanism releases energy to drive the operating shaft to rotate toward the opening position, and the operating shaft in turn drives the real-time energy storage mechanism to drive the remotely-controlled rotary disconnecting switch to be switched to the opened state.

2. The remotely-controlled rotary disconnecting switch according to claim 1, wherein the delayed energy storage mechanism comprises a turntable and a first energy storage spring; the turntable is driven by the operating shaft to rotate from an energy-release position to an energy-storage position, such that the first energy storage spring stores energy; and the turntable is in locking fit with the locking fastener, such that the delayed energy storage mechanism is kept in the energy-storage state; and
when the remotely-controlled rotary disconnecting switch is in the closed state, there is an opening idle stroke between the turntable and the operating shaft, and the operating shaft is driven by an external force to rotate, such that the operating shaft drives the remotely-controlled rotary disconnecting switch to be switched to the opened state through the real-time energy storage mechanism, and passes by the opening idle stroke relative to the turntable simultaneously.

3. The remotely-controlled rotary disconnecting switch according to claim 2, wherein the turntable is coaxially mounted with the operating shaft; the turntable comprises a turntable shaft hole; and at least one turntable driven hole; the turntable is rotatably sleeved onto the operating shaft through the turntable shaft hole; the turntable driven hole comprises a first surface and a second surface; the operating shaft comprises a driving finger, wherein the driving finger is arranged within the turntable driven hole; the driving finger presses against the first surface, such that the turntable rotates toward the energy-storage position; and when the remotely-controlled rotary disconnecting switch is in the closed state, an opening idle stroke is formed between the second surface and the driving finger; and when the delayed energy storage mechanism releases energy, the first energy storage spring releases energy and drives the turntable to rotate toward the energy-release position, and the first surface drives the operating shaft to rotate toward the opening position through the driving finger.

4. The remotely-controlled rotary disconnecting switch according to claim 3, wherein the turntable driven hole is a sector-shaped hole that is concentric with the turntable shaft hole; the sector-shaped hole is provided with a first surface and a second surface at two ends of itself in a circumferential direction, respectively; the delayed energy storage mechanism further comprises a driving key; the driving key is inserted onto the operating shaft in a radial direction of the operating shaft, with two ends of the driving key protruding as driving fingers from the two radial sides of the operating shaft; and the two driving fingers are respectively arranged within the two sector-shaped holes.

5. The remotely-controlled rotary disconnecting switch according to claim 2, wherein the turntable further comprises a turntable locking arm; one end of the locking fastener is rotatably arranged, and another end of the locking fastener is adapted to cooperate with the trip; the locking fastener comprises a locking fastener locking part arranged in a middle of the locking fastener; the turntable rotates from the energy-release position toward the energy-storage position, and the turntable locking arm presses against the locking fastener locking part, such that the locking fastener rotates in a first direction to avoid the turntable locking arm; after the turntable locking arm crosses over the locking fastener locking part, the locking fastener rotates and resets in a second direction, and is in a limiting fit with the turntable locking arm such that the turntable is locked in the energy-storage position; the first direction and the second direction are opposite to each other; and upon receiving a tripping signal, the trip actuates to drive the locking fastener to rotate in the first direction, such that the locking fastener disengages from the limiting fit with the turntable locking arm.

6. The remotely-controlled rotary disconnecting switch according to claim 5, wherein the locking fastener locking part comprises a locking part latching surface and a locking part guide slope; the turntable locking arm presses against the locking part guide slope, such that the locking fastener rotates in an unlocking direction; and the turntable locking arm is in a limiting fit with the locking part latching surface, such that the turntable is locked in the energy-storage position; one end of the locking fastener is rotatably arranged, and another end of the locking fastener is in transmission fit with the trip; the locking fastener locking part is arranged in the middle of the locking fastener; upon receiving the tripping signal, the trip actuates to drive the locking fastener to rotate in the unlocking direction, such that the locking fastener locking part is unlocked from the delayed energy storage mechanism; the locking fastener further comprises a locking fastener main board and a locking fastener driven part; one end of the locking fastener main board is a locking fastener pivoting end, and another end of the locking fastener main board is connected to the locking fastener driven part; the locking fastener is rotatably arranged through the locking fastener pivoting end; a plane where the locking fastener main board is located is perpendicular to a plane where the locking fastener driven part is located; the locking fastener locking part is arranged on the locking fastener main board and is located between the locking fastener pivoting end and the locking fastener driven part; and the locking mechanism further comprises a locking fastener resetting element, which exerts an acting force to the locking fastener, such that the locking fastener rotates in a locking direction, and the locking direction is opposite to the unlocking direction.

7. The remotely-controlled rotary disconnecting switch according to claim 2, wherein the first energy storage spring is a torsion spring, and the first energy storage spring, the turntable and the operating shaft are coaxially arranged; and the delayed energy storage mechanism further comprises a first bushing, which is rotatably sleeved onto the operating shaft and is located between the first energy storage spring and the operating shaft.

8. The remotely-controlled rotary disconnecting switch according to claim 1, wherein the real-time energy storage mechanism comprises a second energy storage spring, a sliding frame, a rotating frame, an output shaft and a housing base; the output shaft is rotatably arranged on the housing base around its own axis; the rotating frame is fixedly connected to and rotates synchronously with the operating shaft; the sliding frame rotates in synchronization with the output shaft and is slidably arranged relative to the housing base and the output shaft; and the housing base comprises two limiting grooves, i.e., an opening groove and a closing groove respectively, which are distributed at intervals in a rotation direction of the output shaft; when the sliding frame is in a limiting fit with one limiting groove, the operating shaft drives the rotating frame to rotate, such that the second energy storage spring stores energy till the rotating frame gets to engage with the sliding frame; the operating shaft continues to rotate and drives the sliding frame through the rotating frame to slide out of the limiting groove relative to the housing base; the second energy storage spring releases energy and drives the sliding frame to rotate and slide into the other limiting groove; and the sliding frame drives the output shaft to rotate simultaneously; and the second energy storage spring is a torsion spring; the second energy storage spring, the rotating frame, the output shaft and the operating shaft are coaxially arranged; the second energy storage spring, the rotating frame, the sliding frame and the output shaft are arranged sequentially; the real-time energy storage mechanism further comprises a second bushing, which is rotatably sleeved onto the operating shaft and is inserted between the operating shaft.

9. The remotely-controlled rotary disconnecting switch according to claim 1, wherein the operating device further comprises a device housing; the device housing comprises a first space for accommodating the delayed energy storage mechanism and a second space for accommodating the real-time energy storage mechanism; the first space and the second space are distributed in an axial direction of the operating shaft; a partition plate is arranged between the first space s and the second space, and is provided with a partition plate shaft hole for the operating shaft to pass through; and one end of the operating shaft protrudes outside the device housing for operation, and another end is inserted into the second space through the first space and the partition plate shaft hole sequentially.

10. The remotely-controlled rotary disconnecting switch according to claim 9, wherein the device housing comprises an upper housing cover, a housing partition plate and a housing base which are arranged sequentially; the upper housing cover and the housing partition plate are buckled to enclose the first space; the housing partition plate and the housing base are buckled to enclose the second space; and the housing partition plate comprises a partition plate.

11. The remotely-controlled rotary disconnecting switch according to claim 10, wherein the delayed energy storage mechanism further comprises a gasket; the gasket is arranged on the housing partition plate of the device housing; and the turntable of the delayed energy storage mechanism is rotatably arranged on the gaskets.

12. The remotely-controlled rotary disconnecting switch according to claim 11, wherein the gasket comprises a gasket avoidance hole for the operating shaft to pass through, a gasket counterbore arranged on the side of the gasket facing the turntable, and a gasket opening; the gasket counterbore has an inner diameter greater than an inner diameter of the gasket avoidance hole; the gasket opening is communicated with the gasket counterbore; a driving key of the delayed energy storage mechanism enters the gasket counterbore via the gasket opening, is inserted into the operating shaft, and rotates within the gasket counterbore.

13. The remotely-controlled rotary disconnecting switch according to claim 10, wherein a first energy storage spring of the delayed energy storage mechanism is a torsion spring; two ends of the tension spring are respectively a first spring fixed end and a first spring driven end; the first spring fixed end is fixedly arranged on the housing partition plate; the first spring driven end cooperates with the turntable of the delay energy storage mechanism; the housing partition plate comprises a turntable stopper; and when the delayed energy storage mechanism is in an energy-release state, and the turntable is in a limiting fit with the turntable stopper, so that the turntable is stopped at the energy-release position.

14. The remotely-controlled rotary disconnecting switch according to claim 13, wherein the turntable comprises a turntable main board, a turntable locking arm and a turntable cooperation arm which are respectively arranged on the turntable main board; the turntable cooperation arm cooperates with the first spring cooperation end; when the delayed energy storage mechanism is in the energy-storage state, the turntable locking arm is in locking fit with the locking fastener; when the delayed energy storage mechanism is in the energy-release state, the turntable locking arm is in a limiting fit with the turntable stopper; a rotating plane of the turntable main board is perpendicular to an axis of the operating shaft; and a plane where the turntable main board is located is parallel to a plane where the turntable locking arm is located.

15. The remotely-controlled rotary disconnecting switch according to claim 13, wherein the housing partition plate is further provided with a housing partition plate spring limiting groove; the first spring fixed end of the first energy storage spring is fixed within the housing partition plate spring limiting groove; and the housing partition plate spring limiting groove is formed on the turntable stopper.
